(19) United States
(12) Patent Application Publication
(10) Pub. No.: US 2006/0109119 A1
(43) Pub. Date: May 25, 2006

(54) RFID tag in a printed circuit board

(76) Inventors: Jeremy Burr, Portland, OR (US); John Hall, Troutdale, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/993,652

(22) Filed: Nov. 19, 2004

(51) Int. Cl. G08B 13/14

(52) U.S. Cl. 340/572.1

(57) ABSTRACT

A radio frequency identification (RFID) tag circuit or RFID tag may be fabricated on a printed circuit board (PCB) and/or on a printed circuit panel from which PCB's are made. In some embodiments the RFID tag may be created early in the fabrication process and become operational before the PCB has been finished.

### BACKGROUND

During the manufacturing process for printed circuit boards (PCBs), multiple copies of a particular PCB are typically created on a printed circuit panel, which is then separated into individual PCBs. Discrete components may be added to the PCBs before and/or after the separation operation. Any automated tracking that is done on the panel or PCBs is typically done by either placing the object in a container that is then tracked, or by applying a bar code to the object that can then be read with a bar code reader. Bar code readers require line-of-sight proximity to the bar code, a fact that may require special handling of the objects. The results of any testing that is done on the panel or PCBs must generally be placed into an external database for later reference, requiring that the database information be transported along with the panel or PCBs.

Radio frequency identification (RFID) tags are sometimes used to identify and track manufactured objects in the stream of commerce (e.g., for inventory control). However, such RFID tags are generally produced elsewhere and then attached to the completed objects or their shipping containers after manufacture, and therefore come too late to be of use during manufacturing operations.

### BRIEF DESCRIPTION OF THE DRAWINGS

The invention may be understood by referring to the following description and accompanying drawings that are used to illustrate embodiments of the invention. In the drawings:

FIG. 1 shows and exploded view of a printed circuit board with an RFID tag circuit fabricated on one of the layers, according to an embodiment of the invention.

FIG. 2 shows a diagram of an RFID tag fabricated on a PCB, according to an embodiment of the invention.

FIG. 3 shows a block diagram of an electronic device, according to an embodiment of the invention.

FIG. 4 shows a flow diagram of a method, according to an embodiment of the invention.

### DETAILED DESCRIPTION OF THE INVENTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, the different embodiments described my have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements co-operate or interact with each other, but they may or may not be in direct physical or electrical contact.

The term “processor” may refer to any device or portion of a device that processes electronic data from registers and/or memory to transform that electronic data into other electronic data that may be stored in registers and/or memory. A “computing platform” may comprise one or more processors.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Various embodiments of the invention may be implemented in one or a combination of hardware, firmware, and software. The invention may also be implemented as instructions stored on a machine-readable medium, which may be read and executed by a computing platform to perform the operations described herein. A machine-readable medium may include any mechanism for storing, transmitting, or receiving information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces and/or antennas that transmit and/or receive those signals, etc.), and others.

This document may use terms that may have slightly different meanings in various other documents, depending on the writer or intended audience. However, within the context of this document, the following terms shall have the following meanings:

RFID antenna—the antenna for an RFID tag for receiving radiated electromagnetic energy and sending a response.

RFID tag circuit—the circuitry, exclusive of antenna, that permits an RFID device to generate a modulated signal in response to radiated electromagnetic energy received through the RFID antenna.

RFID tag—the combination of an RFID tag circuit coupled to an RFID antenna, in which the RFID tag circuit is powered by the electromagnetic energy received through the RFID antenna. The RFID tag may simply transmit data, or may also perform various processing operations such as storing and/or reading data from a memory.

Printed circuit panel—A panel from which multiple copies of a printed circuit board are manufactured. At some point in the manufacturing operation, the panel is cut (or otherwise separated) into individual printed circuit boards. In various embodiments the printed circuit boards may have various levels of stiffness, such as rigid, flexible, or semi-rigid.

Printed circuit board manufacturing area—that part of the printed circuit panel from which the multiple printed circuit boards are manufactured. Due to space, handling, and/or geometry considerations, the panel may include one or more areas external to the printed circuit board manufacturing area.

Printed circuit board area—the area of a printed circuit panel that becomes a single printed circuit board. The printed circuit board manufacturing area may include multiple printed circuit board areas.

Various embodiments of the invention may relate to RFID tags (or alternately just the RFID circuit for those tags) that are fabricated onto PCBs in various ways. In the context of this document, the term ‘fabrication’, and its derivatives, refers to forming a circuit, including active elements, directly on at least one layer of a PCB though techniques such as plating, etching, silk screening, and direct printing. Physically attaching pre-manufactured circuit elements to the PCB is not considered fabrication in this document, although it may be performed in addition to fabrication. Within this document, fabricating a circuit on the PCB area of a printed circuit panel is considered the equivalent of fabricating a circuit on a PCB.

In some embodiments the RFID tags may be fabricated and become operational before manufacture of the entire PCB has been completed. In some embodiments such RFID tags may be located between different layers of a multi-layer PCB. By completing an RFID tag and making it operational when the early layers of the PCB are being manufactured, the RFID tag may be used to receive, store, and disclose information during the remaining fabrication and/or manufacturing operations, without the need to apply any operational power to the PCB. Such information may be used for any feasible purpose during the manufacturing operation, such as revision number, configuration data, intermediate test results, etc. An RFID tag may also be fabricated on a printed circuit panel external to the PCB manufacturing area, for information that may be specific to the panel but not to the individual PCBs.

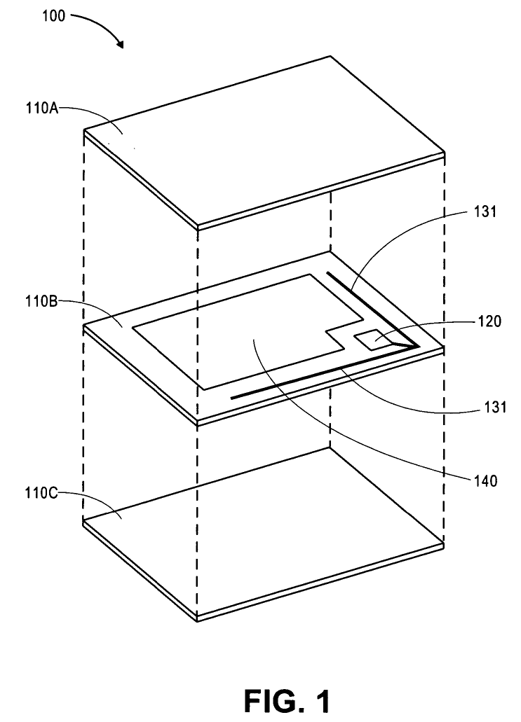

FIG. 1 shows an exploded view of a printed circuit board with an RFID tag circuit fabricated on one of the layers, according to an embodiment of the invention. The illustrated PCB 100 is a multilayer PCB with three layers 110A, 110B, and 110C, but other embodiments may have one, two, four, or more layers. The illustrated PCB 100 shows the RFID tag circuit 120 fabricated on an inner layer (such as layer 110B), although other embodiments may have the RFID tag circuit on an outer layer (such as 110A or 110C).

An RFID antenna may also be created on one of the layers and coupled to the RFID tag circuit 120. The illustrated embodiment shows an antenna 131 with two segments, although other embodiments may use other antenna configurations. The illustrated embodiment shows the antenna on the same side of the same layer as the RFID tag circuit, although other embodiments may place the antenna on a different layer, or on the opposite side of the same layer, as the RFID tag circuit with vias or other types of electrical connections to couple the tag circuit and antenna together. The antenna may be created using various techniques, such as but not limited to: 1) using the same technology used to fabricate the RFID tag circuit 120, 2) creating metal traces on the layer, such as by using a mask-etch process, 3) attaching a discrete wire or other antenna object to the layer, 4) etc.

The PCB may also be constructed with other circuitry that may not be necessary for operation of the RFID tag, such as that indicated at 140. Such other circuitry may be located on one or more layers of the PCB. In some embodiments, such other circuitry may be electrically isolated from the RFID tag circuit. In other embodiments, such other circuitry may be electrically connected to the RFID tag circuit. Such other circuitry may be in an incomplete state when the RFID tag becomes operable.

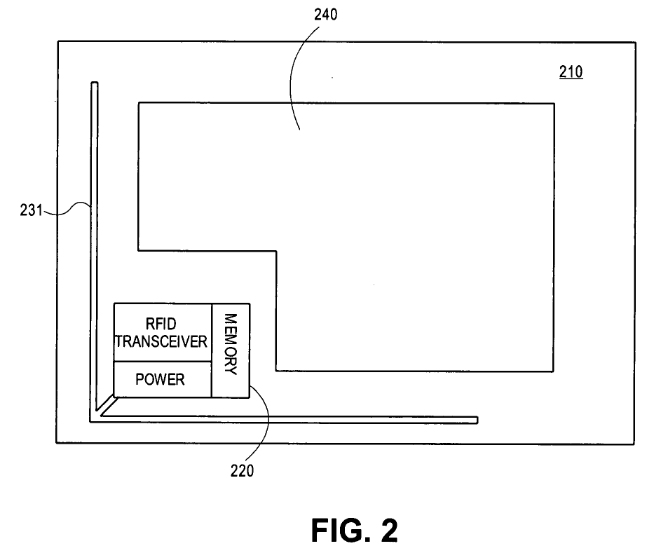

FIG. 2 shows a diagram of an RFID tag fabricated on a PCB, according to an embodiment of the invention. In the illustrated embodiment, RFID tag circuit 220 may be fabricated on PCB layer 210, and be electrically connected to antenna 231. The RFID tag circuit may comprise separate circuits for power, the RFID transceiver, and a memory that can be written into and read from by other portions of the RFID tag circuit when the RFID tag is operating. In some embodiments it may also be possible for other circuitry (such as but not limited to other circuitry 240) on the PCB to be electrically connected to the RFID tag circuit 220 and/or be capable of interacting with the RFID tag circuit 220 while such other circuitry is powered, although this feature might only be available after manufacturing of the PCB is complete.

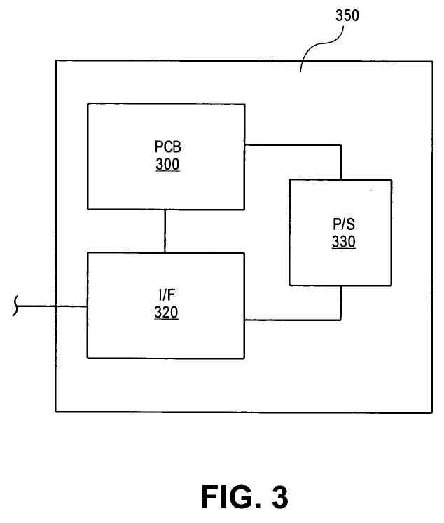

FIG. 3 shows a block diagram of an electronic device, according to an embodiment of the invention. In the illustrated embodiment, electronic device 350 comprises a PCB 300 with an RFID tag fabricated on it, an interface 320 that permits the electronic device 350 to communicate with other electronic devices, and a power supply 330 to provide electrical power to PCB 300 and interface 320. The electronic device 350 may also contain other components not shown. The RFID tag on PCB 300 may be an RFID tag as described elsewhere in this document. The interface 320 may comprise any suitable interface, such as but not limited to a local area network interface, a wireless communications interface, an optical communications interface, a bus interface, etc. The power supply 330 may comprise any suitable power supply, such as but not limited to a battery, a power supply coupled to an electrical outlet, a power supply located internal to electronic device 350, a power supply located external to electronic device 350, etc. The power supply may be mounted or connected in any feasible way, such as but not limited to mounting on a chassis or mounting on one or more of any PCBs in electronic device 350.

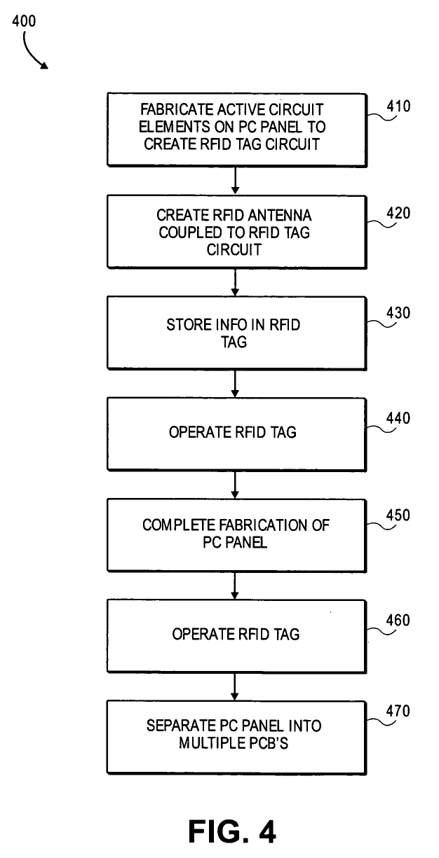

FIG. 4 shows a flow diagram of a method, according to an embodiment of the invention. In flow diagram 400, at 410 a fabrication process may be used to fabricate active elements directly on a PC panel, and to fabricate enough other circuit elements to create an RFID tag circuit on the PC panel. The process may comprise any feasible fabrication process, such as but not limited to printing the circuit elements directly onto the PC panel using conductive and/or semiconductive ink printing technology. At 420 an RFID antenna may be created on the PC panel, coupled to the RFID tag circuit to form an RFID tag. The RFID antenna may be created with any feasible technique, such as but not limited to the aforementioned printing with conductive ink, etching metal traces on the panel, etc. The panel may be a single-layer panel or a multi-layer panel.

In some embodiments, at 430 information may be stored into a memory in or connected to the RFID tag circuit, such as a non-volatile memory. Such information may relate to any feasible subject, such as but not limited to the results of tests conducted on the PC panel before the storing operation of 430. The RFID tag may be operated at 440 by directing electromagnetic radiation towards the RFID tag and reading the signal returned from the RFID tag. The operation of the RFID tag may be used for any feasible purpose, such as but not limited to identifying the PCB that is being created in the area of the RFID tag, reporting test results from a test operation that occurred before 440 but not specifically described in flow diagram 400, identifying the PC panel for future reference, etc. In some embodiments, there may be an RFID tag for the PC panel itself, located on the PC panel outside the PCB manufacturing area.

At 450, other fabrication operations may be performed to complete the PC panel. Such fabrication operations may include one or more of, but are not limited to, etching conductive metal traces, printing additional active circuit elements, completing fabrication of additional layers in a multi-layer PC panel, etc.

At 460 the RFID tag may be operated again, for any feasible purpose such as but not limited to reporting the results of additional tests, verifying the RFID tag still operates properly, etc. At 470 the PC panel may be separated into multiple PCB's. Although operating the RFID tags again and separating the PC panel into multiple PCBs are shown in a particular order in FIG. 4, this order may be reversed in some embodiments. In some embodiments, additional operations not shown may be performed at any feasible point in the illustrated process, such as but not limited to additional operations of the RFID tags, conducting tests on the circuits being created, attaching discrete components to the PC panel, etc.

Although flow diagram 400 is described with respect to a single RFID tag, in some embodiments there will be a separate RFID tag for every PCB that is to be created from the PC panel and where applicable the described operations may be performed on multiple ones of those RFID tags.

The foregoing description is intended to be illustrative and not limiting. Variations will occur to those of skill in the art. Those variations are intended to be included in the various embodiments of the invention, which are limited only by the spirit and scope of the appended claims.

What is claimed is:

1. An apparatus comprising
a printed circuit panel comprising
a radio frequency identification (RFID) tag circuit fabricated on the printed circuit panel; and
an RFID antenna disposed on the printed circuit panel and electrically coupled to the RFID tag circuit.

2. The apparatus of claim 1, wherein:
the printed circuit panel is a multi-layer printed circuit panel;
the panel further comprises a second circuit; and
the RFID tag circuit is disposed on at least one particular layer of the multi-layer printed circuit panel that enables the RFID tag circuit to be operational before completion of the second circuit.

3. The apparatus of claim 1, wherein the RFID tag circuit is disposed external to a printed circuit board manufacturing area on the printed circuit panel.

4. The apparatus of claim 1, wherein the RFID tag circuit is disposed internal to a printed circuit board area on the printed circuit panel.

5. The apparatus of claim 1, wherein the RFID tag circuit comprises circuit elements printed onto the printed circuit panel.

6. The apparatus of claim 1, further comprising other circuitry electrically coupled to the RFID tag circuit.

7. The apparatus of claim 6, wherein the other circuitry is adapted to perform at least one of reading from a memory in the RFID tag circuit and writing into the memory in the RFID tag circuit.

8. A method, comprising:
performing fabrication operations on a printed circuit panel to produce a radio frequency identification (RFID) tag and another circuit in each of multiple printed circuit board areas of the panel, the fabrication operations being sufficient to make the RFID tag operational and insufficient to make the other circuit operational.

9. The method of claim 8, further comprising operating the RFID tag subsequent to said performing the fabrication operations.

10. The method of claim 9, further comprising performing, subsequent to said operating, additional fabrication operations on the other circuit.

11. The method of claim 10, further comprising separating the printed circuit panel into individual printed circuit boards subsequent to said performing additional fabrication operations.

12. The method of claim 1 1, further comprising operating the RFID tags again subsequent to said separating.

13. The method of claim 8, wherein said performing the fabrication operations comprises fabricating circuit elements on the PCB using semiconductive ink printing technology.

14. An apparatus comprising
a multi-layer printed circuit board (PCB) comprising:
a radio frequency identification (RFID) tag circuit fabricated on a layer of the multi-layer PCB; and
an RFID antenna coupled to the RFID tag circuit.

15. The apparatus of claim 14, wherein the RFID antenna comprises a conductive trace disposed on a same layer of the PCB as the RFID tag.

16. The apparatus of claim 14, wherein the RFID antenna comprises a conductive trace disposed on different layer of the PCB as the RFID tag.

17. The apparatus of claim 14, wherein the fabricated RFID tag circuit comprises a circuit created with semi-conductive ink printing technology.

18. The apparatus of claim 14, wherein the layer is an inner layer of the PCB.

19. A system, comprising
an electronic device comprising:
a power supply;
a printed circuit board (PCB) coupled to the power supply and comprising a radio frequency identification (RFID) tag circuit fabricated on the PCB and an RFID antenna coupled to the RFID tag circuit.

20. The system of claim 19, wherein the RFID antenna comprises a conductive trace disposed on the PCB.

21. The system of claim 19, wherein the RFID tag circuit comprises a circuit created with semi-conductive ink printing technology.
